(19) United States
(12) Patent Application Publication
(10) Pub. No.: US 2008/0238613 A1
(43) Pub. Date: Oct. 2, 2008

(54) Using Rfid Tags with an Incorporated Chip to Identify and Locate Persons

(76) Inventor: Eduardo Luis Salva Calcagno, Buenos Aires (AR)

Correspondence Address: JACOBSON HOLMAN PLLC, 400 SEVENTH STREET N.W., SUITE 600, WASHINGTON, DC, 20004, US

(21) Appl. No.: 10/586,912

(22) PCT Filed: Jan. 21, 2005
(86) PCT No.: PCT/US05/01870

§ 371 Date: Jul. 24, 2006

(30) Foreign Application Priority Data
Jan. 23, 2004 (AR) P040100214

(51) Int. Cl. G05B 23/00

(52) U.S. Cl. 340/5.83

(57) ABSTRACT

A procedure to identify and locate people that, starting with known methods of fingerprint recognition, classifies the prints according to the Vucetich method (D), subclassifies them according to the previous classification (E), converts them into alphanumeric codes (I), and then converts these into barcodes (J). The procedure includes a grid or plotting device where the characteristic points of the fingerprint are determined (C). Once the alphanumeric code has been obtained, conversion systems in the device transform it into a magnetic barcode and print it onto a tag or label that contains a hidden radio frequency chip that emits signals (K). The device includes a reader that issues a signal on a predetermined frequency to all of the RFID tags within its range. These tags return, via radio waves, a signal that contains information. Both the reader and the tags communicate using electromagnetic fields created by the antenna.

### TECHNICAL FIELD

This invention proposes applying RFID technology (Radio Frequency Identification Tags) to crime prevention, terrorism and drug trafficking control, identity theft, immigration control, and anti-falsification of financial documents from treasury bonds to paper currency and of government-issued personal identification documents.

The proposed radio frequency identification procedure (RFID) uses, in most cases, passive electronic tags that emit information for readers or that reflect signals coming from these readers and that make up part of a wireless network. The printing of these labels or tags that issue signals is part of a person identification procedure that, starting with the known methods of fingerprint recognition, classifies these prints according to Vucetich's method, subclassifies them according to the fundamental group to which they belong, converts them into alphanumeric codes, and then coverts these into barcodes. Once the barcode for a fingerprint has been obtained, a tag is printed that contains a radio frequency chip with a unique code. This chip is not visible to the eyes of the document bearer and is located underneath the barcode generated by the system using the person's own fingerprint.

The entire proposed procedure is put into practice using a device especially designed for that purpose.

### GENERAL DESCRIPTION OF THE INVENTION

The proposed person identification procedure is put into practice using a device that includes identification software capable of classifying information, transforming it into alphanumeric codes, and then to bar codes.

This device consists of a series of apparatuses or devices that when they are used according to the proposed procedure let you obtain the desired result.

The device consists of a flatbed scanner, a fingerprint sensor, a digital camera or any other similar digital medium that can reproduce the digital image of a fingerprint. This scanner or other digital medium is connected to a computer that has software that is capable of converting fingerprints and genetic codes into barcodes, a process that will be described in detail further on. In addition, this computer has a type of laser barcode reader currently available on the market.

This same computer is connected to a general database where the records containing the State or country's information about the person is going to be kept. This database has a database engine or administrator that can be in the same computer or in a separate server, depending on the volume of information to be stored.

Finally, the device has a laser or thermal printer capable of printing the resulting barcodes onto both self-adhesive labels and sheets of paper that have the quality necessary to be read without difficulty by the aforementioned laser reader.

The proposed invention constitutes a safety tool to be used by States, countries, governments, and other institutions, primarily for access control, although it can be extensively used in other kinds of fields, for example, financial and police institutions.

This safety tool has a person's identifying information condensed into a barcode. This information is complete and includes the fingerprint of the person you want to identify, his personal data, and his anthropometric distinguishing features and other civil and criminal data that a person may accumulate throughout his life.

This process is achieved by combining the technologies described above plus applying a unique formula to classify and subclassify prints and then transform them into an alphanumeric chain.

The fingerprint is then transformed into a barcode that can be used to identify a person, and the user can directly view this information on a computer screen that is part of the device used in the proposed procedure.

The aforementioned barcode consists of a series of black bars and white spaces of different widths, resulting from a biometric, numeric, and alphabetic combination that stores the previously selected and analyzed fingerprint information on a grid especially designed for that purpose.

This procedure, which is based on the particular device described above, presents two main features in its use: the speed and safety in transmitting the information.

A code containing a fingerprint in an information of X characters can be read, decoded and entered into a computer in under one second, over seven times less than if it were to be done manually. In addition, the accurate transmission guarantees the safety of 100% of the data.

Another obvious advantage versus known systems is that when a fingerprint is entered into them to be identified you have to search all databases to look for common points, while the proposed procedure preclassifies the prints and then converts them into alphanumeric codes first and then barcodes. This means that the search will be noticeably faster, since the system only has to look in a subgroup of common prints fitting a determined parameter, making it unnecessary to search in the other groups that have different characteristics. This is a distinct advantage when you compare the problems this invention solves compared to the history of the state of the technique.

To create a barcode of a fingerprint, a process is started that generates a numeric code generally linked to another alphabetic code and combined with another print biometric reader. That way a system that is tremendously easy to implement for any kind of personal identification document is generated, which—regardless of their size or function—will be printed in the form of a barcode instead of an actual fingerprint (Identity Cards, Social Security Number, Passports, Driver's Licenses, social welfare program cards, credit cards and other civilian, military, and diplomatic credentials, etc.).

It should be mentioned that this system can be vastly applied in different areas. Therefore, it would be true to say that the proposed procedure can be used anywhere information needs to be captured, previously coded in a database. Combined with data collection technology, barcodes provide a fast, accurate and efficient way to collect, process, transmit, register, and protect information on identity cards as a safety barcode that condenses fingerprint information and a genetic code, onto which a radio frequency chip capable of emitting signals is hidden.

The purpose of the proposed invention is to provide a procedure that can be used to silently track individuals who could potentially commit crimes and attacks, by converging several technologies that will allow States or nations having this capacity to have abundant information, to be alert and to even be active in their response.

There are several methods of identification, but the most common one is to store a serial number identifying a person or object and perhaps other information in a microchip attached to an antenna (the chip and the antenna are collectively called an RFID transmitter or and RFID tag). The antenna enables the chip to transmit identification information to a reader. The reader converts the radio waves reflected from the RFID tag into digital information that can be then sent to computers that are able to use it.

RFID technology requires a reader that can issue a signal at a preset frequency to all of the RFID tags found in its range. In turn, these tags return, over radio waves, a signal that contains information. Both of these items—the reader and the tags—communicate through electromagnetic fields created by an antenna. These tags let you track a few people on a smaller scale and also a large number of people on a larger scale.

Although RFID tags usually tend to be passive (meaning that they do not receive energy from a battery or from any other source), active RFID tags also exist.

One known example are passes people who drive to work in their cars can use that let them go through tollbooths without having to stop and count coins.

Other variants this invention provides are labels or tags that are equipped with sensors and MEMS. Sensors are more complex that RFID tags and can detect information about the area surrounding it, transmit this information or react to it. Recent manufacturing and engineering advances have produced more accurate, more reliable, and less expensive sensors than the ones that had existed in the past.

Technological advances have also provided us with micro electro-mechanical systems (MEMS), a type of minute sensor, and movement systems that have electrical and mechanical elements. If we consider that sensors give objects the ability to feel, see, smell and sound, movement systems give them arms and legs, meaning it gives them the ability to respond to what they perceive. The device found in the airbag of your car is an MEMS: An acceleration meter (sensor) detects the sudden deceleration of a vehicle, and the MEMS activates the airbag.

MEMS use the same manufacturing technology as computer chips, but they can be adjusted to perceive and act in terms of different physical phenomena.

RFID tags, sensors, and MEMS enable any identity document, passport, etc. to be “intelligent” to various extents.

This way, the Immigration Department and other State security agencies can use this silent tracking capability and will be able to know where a passport is and, consequently, where the individual is who is carrying it, and can track this person's movements or make the device respond appropriately to its surroundings.

Locating an object can be done in several ways with regard to different distances.

In a small area, passive RFID tags can indicate an object's location when its reader passes over a control point or antenna.

Active RFID tags can transmit an object's identity from a little further away. Recently developed wireless technologies like Bluetooth make it possible for intelligent objects to “know” when they are near another intelligent object so they can communicate with one another.

When the distance is greater, the technology to apply becomes more complex. For example, mobile phones “transmit” their identities and can be located in terms of the cell they are in or their triangulated position between several cells. For objects that move over great distances, locating them can be done using the global positioning system (GPS). This involves a global satellite radio navigation system, which the military has been using for a long time, where radio signals are sent from satellites, triangulated by the receiver, and used to verify positioning and time.

Each tag carrying the radio frequency thread will have an exclusive identification, and no two can be the same. The tag placed in the passport or identity document will provide the geographic location of the passport and, hence, the individual, and an entire spectrum of information about his movements, and this information will be fed into a database that controls foreigners and citizens entering and leaving the country.

However, the new applications should be integrated into existing processes and in the systems we have inherited. Improvements in operational efficacy and increased safety will, of course, be the result of this.

### BRIEF DESCRIPTION OF THE FIGURES

FIG. 1A shows a flow chart of stage 1 (a), when a traveler comes into his Consulate or Embassy to travel to another country.

FIG. 1B shows the flow chart for stage 1 (b), when a traveler comes into the Immigration office of the destination country without having gone to the Consulate or Embassy.

FIG. 2 shows the flow chart of step 2, which consists of converting a fingerprint into a barcode.

FIG. 3 shows a flow chart for step 3, when an RFID tag is issued that is to be affixed to the passport and a permanent card with an RFID is issued.

FIG. 4 shows step 4, when a traveler leaves the country before his immigration document expires.

FIG. 5 shows the flow chart for step 5, when a traveler does not leave the country on time and his immigration document expires.

FIG. 6 shows the image of a digitalized fingerprint;

FIG. 7 shows the image of FIG. 6 in a grid-like chart;

FIG. 8 shows the four fundamental groups of fingerprints;

FIG. 9 shows fingerprint subclassifications;

FIG. 10 shows the core loop and delta subclassification elements;

FIG. 11 shows various fingerprint subclassifications;

FIGS. 12A and 12B show further subclassifications;

FIG. 13 shows minutiae patterns;

FIG. 14 shows an example of fingerprint identification;

Images 1 and 2 show fingerprint cards;

Image 3 shows individual segmentation;

Image 4 shows an example of a fingerprint with adequate quality;

Image 5 shows a fingerprint with a marked core;

Image 6 shows a gray scale and a binarized fingerprint;

Image 7 shows an orientation graph;

Image 8 shows a graph to a print; and

Image 9 shows a fingerprint with a grid.

### DETAILED DESCRIPTION OF THE INVENTION

This invention provides a person identification and location procedure using radio frequency tags (RFID) that have a chip incorporated. This intelligent chip is activated with a radio frequency from a varied band width and whose signal has enough amplitude to be detected from the emission source and the receiving base or source. The electromagnetic and radio frequency fields are wide enough to be detected from satellites.

The chip is activated to generate a radio frequency in non-ionized radiations that do not have enough energy to produce ionization.

The RFID tags are made up of two essential components: a silicon microprocessor and an antenna. The microprocessor receives and transmits information, like a product identification number, using the antenna. These components can exist either as a separate tag or they can be put directly on the passport. The information contained in the microprocessors can reach it by means of a radio frequency signal created by a “reader,” which is an electronic module connected to its own antenna and to a computer network. The reader sends a specific signal from its antenna to the RFID tags in the immediate area. These tags then respond with a message, transmitting their exclusive identification number from the barcode the system prints based on a person's fingerprint, and the reader processes and transmits this information to a computer network. This way, for example, the Immigration Department could know how many people have broken immigration laws through a number assigned to that passport.

The RFID tag is made up of a reader that issues a signal at a predetermined frequency to all RFID tags found in its range. In turn, these tags return, over radio waves, a signal that contains information. Both the reader and the tags communicate by way of electromagnetic fields created by an antenna.

RFID tags are flexible and very thin. They include a 13.56 Mz RF antenna and a chip where a person's identification is stored. The same RFID technology should obviously be incorporated in immigration readers and barriers.

It is a system for obtaining information quickly, without the need of human intervention, and can be used in many applications within the field of automatic identification and data capture (AIDC). It includes a reader that emits a signal on a certain frequency to RFID tags within its reach. These RFID tags contain information that is communicated via radio waves through an electromagnetic field created by a flat antenna. The radio signal transmitted via the reader's antenna is received by the tag with its own antenna and activates an integrated circuit (1 mm. square chip); data are exchanged and are sent through cable or LAN interfaces to central computer systems for processing and control. Tag components, called transponders, automatically respond to an outside signal and do not require connections or cables or a line of vision between the reader and the identified object.

Everyone requiring identification who is located within the range of the reader systems is registered simultaneously without interference from environmental conditions where the signal is being read, like humidity, dust, or the temperature. Since the performance capacity of the RFID tags is dynamic, not static, the signals emitted and received within the electromagnetic field pass through packaging.

The tags can be read even if there are barriers such as paint, ice, fog, snow, or any visual or environmental condition.

The fact that the system does not require contact or a line of vision between the reader and the object is an advantage that enables tracking in special conditions, such as high speed communication, for example, in a control booth without this affecting identification safety, because the RFID tag responds in under 100 milliseconds.

The system's capacity lets you exchange or update coded data on the tags during the tracking cycle, maintaining the information up to date on the location map. This condition enables interaction reading/writing applications that are ideal in information flow where data are fed back and cannot be controlled other than by two-way information.

The tags proposed in this invention can be of three types: passive, semi-active, and active.

Passive intelligent tags: They are transponders that do not require an integrated power source. The interrogator or reader transmits an energy field that activates the tag and supplies a current to transmit or program data. Even though these tags are the most economic, they also have a useful life of operation that is virtually unlimited; the only factor is the resistance of the material, since the tags are not conditioned upon the duration of a battery. They require more power from the readers and operate in shorter ranges. They are basically for data reading.

Active and semi-active tags: They are fed by an internal battery that provides the energy they need to process reading and writing. A tag's data can be rewritten and/or modified. A tag's storage capacity depends on its field of application, and it also combines permanent data storage as a serial number, for example, with variable registers. This intelligent tag can record, read or combine both tasks. To do this it has another memory for coding and for subsequent updates that will become part of the tag's history. The energy supply allows it to have greater reading ranges, although its useful life is limited by the duration of the battery (no more than 10 years).

Another variation of tags this invention provides are tags that use conductive inks.

Conductive inks permit the flow of electricity, because they act as circuits, antennas or resistances, what some people have called “paper electronics.” Conductive particles or special materials like conductive polymers are compressed and dispersed, replacing antennas and copper coils, and they are applied onto rigid, traditionally flexible substrates and printed using serigraphy. Conductive inks permit the flow of electricity in such a way that they can act like wires, resistances, or antennas. Conductive inks can be composed of either finely dispersed conductive particles or more exotic materials like conductive polymers. They are used to produce conductive patterns on both rigid and flexible substrates. For RFID technology, conductive inks are used as antennas that receive the wireless flow of information from a computer that has RFID capacity.

To print these conductive inks, high speed printing processes are used to print tag or label antennas.

Another proposed tag type is one that can be read only or read/write. Read only tags are assigned an identification number that cannot be modified, but in most cases it can be read multiple times. Read/write tags, on the other hand, allow the information they contain to be updated whenever needed. Both approaches have their own advantages in certain situations.

The use of conductive inks instead of antennas stamped or etched in metal and on the several frequency bands used by RFID technology is an effective solution to the unit cost of the proposed tags for two reasons. First, the material cost of the conductive ink can be a lot lower than the cost for traditional stamped or etched antenna. The stamping and etching processes are known as substractive processes, since they remove unused material. Secondly and more importantly, because high speed printing processes are fast and additive, applying conductive ink on an antenna or circuit takes a lot less time and can be more economical than other alternatives.

Below we are going to describe the complete person identification and location procedure using radio frequency tags (RFID) with a chip incorporated, including the fingerprint generation process and its barcode coding.

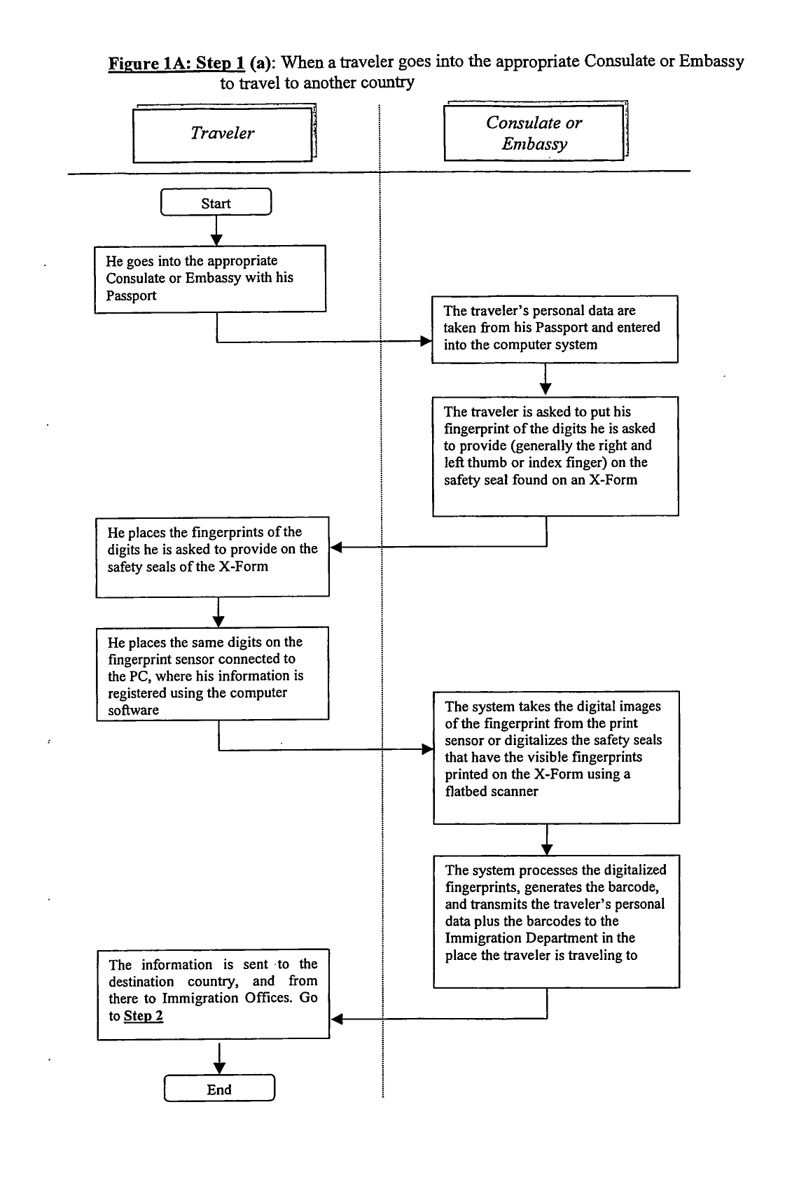

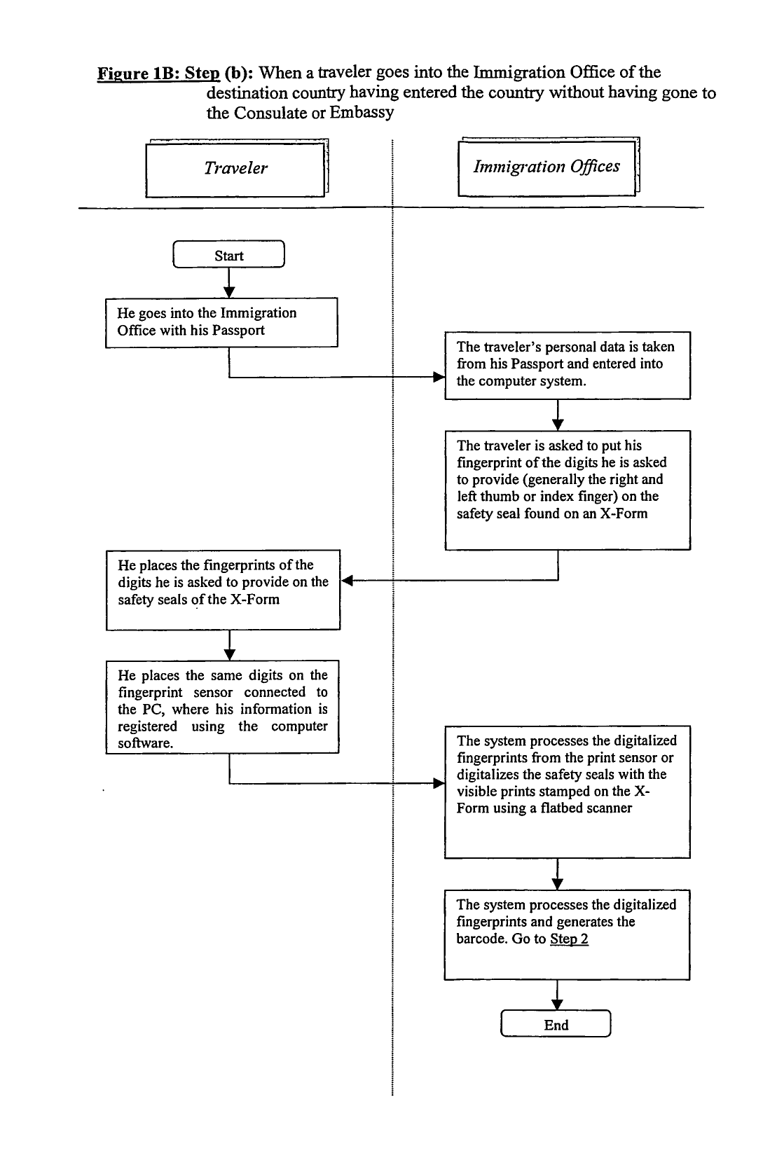

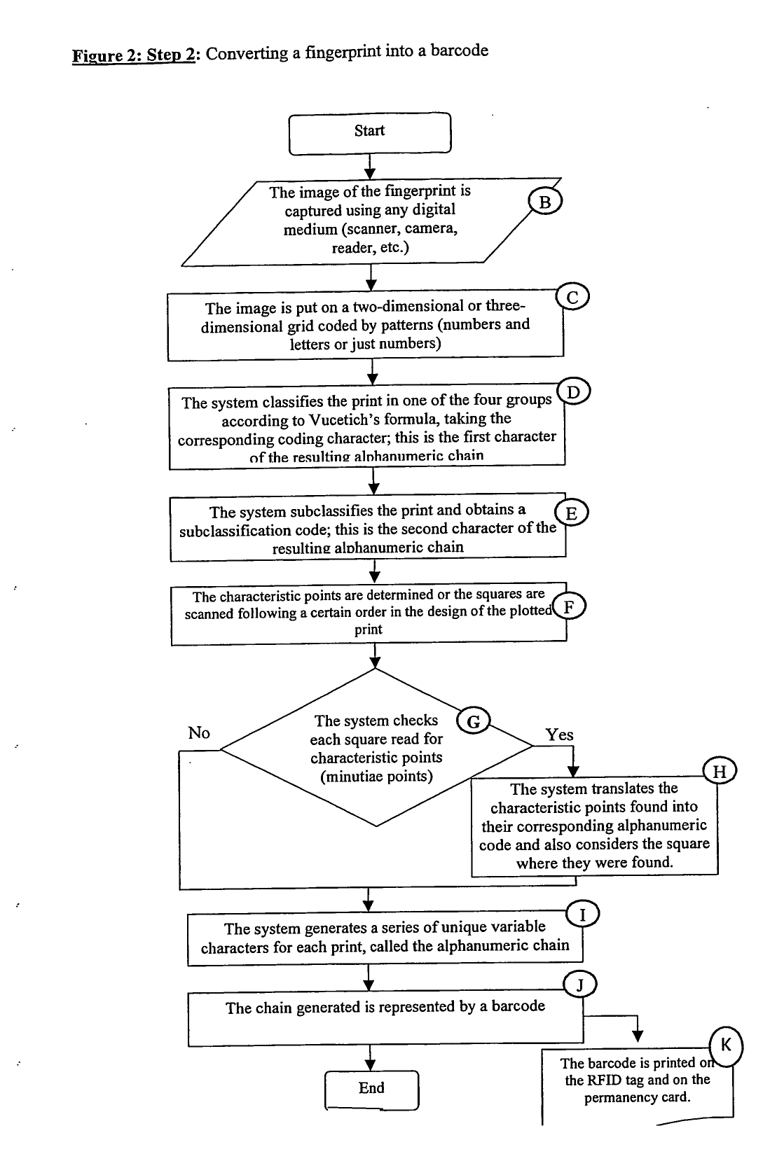

FIG. 1A, Step 1(a): The Traveler Goes in to the Consulate or Embassy to Travel to Another Country.

The traveler presents his Passport at the Immigration Department, and then the traveler's personal data found on his passport are entered into the computer system.

The traveler is asked to provide a fingerprint of the digits he is requested (generally the right and left thumb or index finger) on a security seal provided on an X-Form.

This organic safety seal disclosed in U.S. Pat. No. 6,659,038 filed by this applicant is incorporated herein as reference, in addition to its improvement disclosed in Argentina application P 04 01 01743 that is being processed.

This safety seal consists of a device that is capable of storing the fingerprint and DNA of the person entered into the system that is taken from his fingerprints by way of reactives and microscopic readings that can lift the organic remains of cells attached to the adhesive material of the organic safety seal.

This X-form consists of the aforementioned safety seal to capture a certain number of prints and is a supporting device capable of storing the fingerprint and the DNA of the person input into the system, rendering unnecessary the use of intrusive methods like the ones currently used (blood or hair samples or skin analysis, etc.)

Next, the traveler places the same digits on a fingerprint sensor connected to a PC in which his data is registered through the software provided by the device used in this procedure.

The system takes the digital fingerprint images from the print sensor or digitalizes the safety seals with the visible prints stamped on the X-Form using a flatbed scanner.

Depending on the digitalization device you are using, there may be two alternatives to capture a fingerprint. In the first one, the fingerprint image digitalization process has to be initiated by a software order (i.e., low production flatbed scanner).

The software takes the previously set parameters to perform the digitalization, such as:
Horizontal and vertical resolution: 500 dpi
Bit depth: 8
Color: 256 gray
Digitalization area(s): variable

The software checks that the device is connected and working properly; then it orders the connected device to start digitalizing the fingerprint image or images found on the X-Form with the pre-set parameters.

Next, the software receives the digitalized fingerprint images into its memory. In the second alternative for capturing a fingerprint, the digitalization device captures the image(s) of the fingerprint and then transfers it to the software (i.e., fingerprint sensor, digital camera).

The digitalization device capturing the image of the fingerprint must at least meet the following specifications:
Horizontal and vertical resolution: 500 dpi
Bit depth: 8
U Color: 256 gray

Next, the device makes the transfer and the software receives the digitalized fingerprint image(s) into memory.

Then the system processes the digitalized fingerprints and generates a unique, unrepeatable barcode. This process is described in step 2.

FIG. 2, Step 2: Converting a Fingerprint into a Barcode.

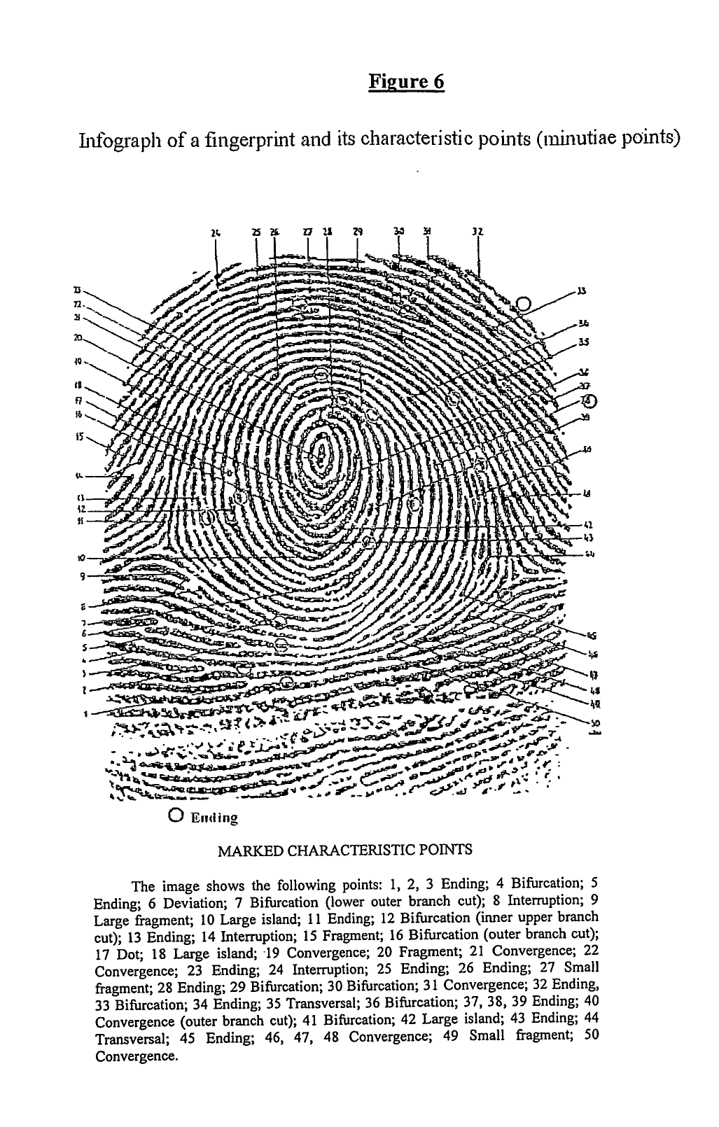

To do this, we copy the fingerprint shown in FIG. 6 and plot it on a grid of predetermined segments and measurements, which are identified by letters and numbers; that is to say, an alphanumeric grid. This grid or chart is a novelty and is part of the invention, because it backs up all subsequent actions of the system.

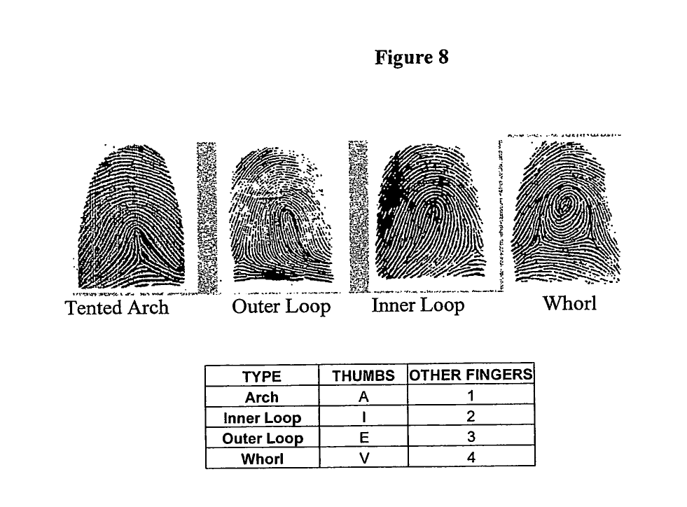

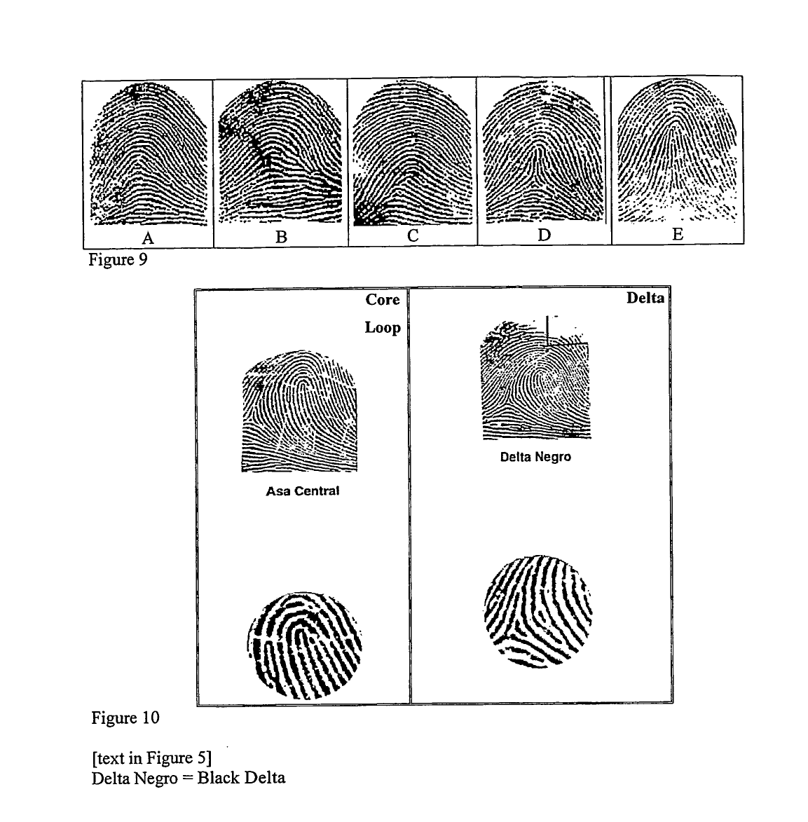

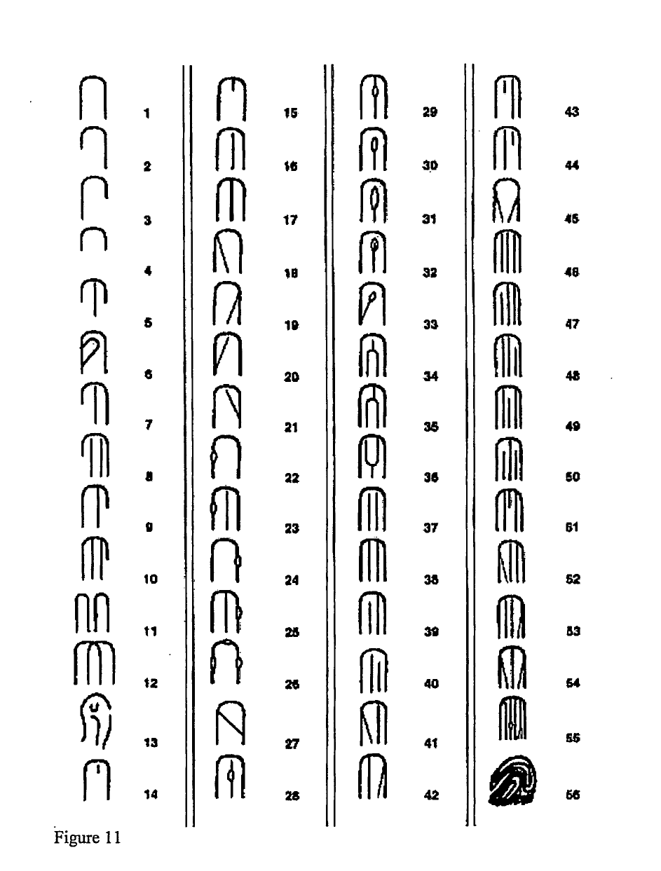

Through this process, the software first obtains the classification of the type of fingerprint according to the Vucetich classification (FIG. 8), and it falls into one of the four fundamental groups in existence. The print is then subclassified according to fundamental group, and then the minutiae patterns or characteristic points found in the image are extracted.

FIG. 6 shows the image of a digitalized fingerprint taken by a digital camera, optic scanner or any other imaging device.

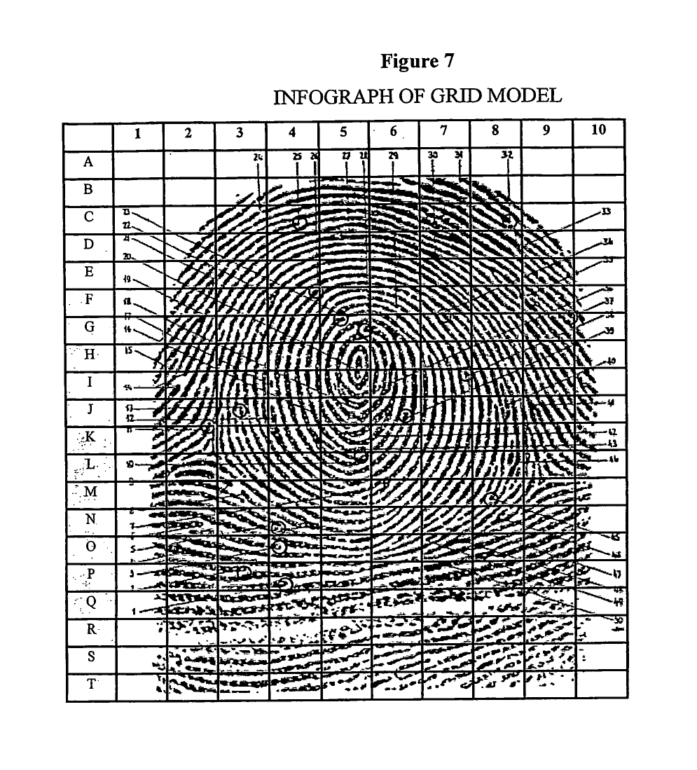

Once the image has been captured, the software of the proposed device classifies it into one of four groups according to the Vucetich formula and then subclassifies it according to the fundamental group to which it belongs. Then it plots the print in question onto a grid-like chart, like the one shown in the representative model (see FIG. 7), where the minutiae points called the outlined characteristic points (FIG. 6) are determined and coded through the system's own techniques.

In this way we obtain an alphanumeric code from the fingerprint image that is transformed using the invention's conversion system, representing it in a one-dimensional or two-dimensional magnetic barcode.

Following is a description of the process on how to obtain a character chain from a fingerprint image.

Once the image has been captured (step B) and plotted on a two-dimensional or three-dimensional grid (FIG. 2) shows the plotting of a two-dimensional image), it is coded by patterns (C). Once the image is in the memory as a result of having been digitalized (B), the software, in the event the image in memory corresponds to several fingerprints, performs a multiple segmentation, which means that it divides an image containing several fingerprints into several separate images, each containing one fingerprint. For example, if the data medium is a two-finger form, the software divides it into two separate print images; if it is a ten-finger card, it divides it into ten separate print images, etc. (see Images 1 and 2).

Once the images have been divided, work is done on each of them individually, starting with the first image obtained, by applying the processes that are going to be described further on until a character chain is obtained from the fingerprint, and the process continues in this manner until all the segmented images have been processed.

In the event the image in memory is of just one fingerprint, the multiple segmentation process is not applied and you proceed directly as indicated below.

Continuing with step (C), the next step for obtaining a code from each print is the individual segmentation process, eliminating the pixels that do not belong in the image of the fingerprint. With this, you get a smaller image than the original one and make it unnecessary to go over the image repeatedly, which lets the following operations that need to be done on the image be done faster and more accurately since you have eliminated information that does not belong to the print and that could introduce calculation errors (see Image 3). Once the segmentation process has been completed, the software automatically performs a process to improve the image to eliminate noise, which is garbage that may have been introduced during the digitalization process or that comes from scanning the original image.

To do this, Fourier's two-dimensional transformation is applied to convert the data from the original representation into a frequency representation.

Then a nonlinear function is applied so that the most useful information has more weight compared to the noise. Finally, the improved data are converted into a spatial representation.

The software then analyzes the quality of the image. This analysis will allow you obtain a quality index for the print and check whether the software should accept or reject the print depending on that index. This process analyzes the image and determines areas that are degraded and that are very likely to cause problems or lead to errors during subsequent analyses.

The quality analysis includes determining the directional flow of the ridges in an image and detecting regions of low contrast, low ridge flow and high curvature. These last three conditions represent areas in the image where the detection of minutiae points is unreliable and together can be used to represent quality levels in the image.

If the software determines that the image has enough quality it needs, it processes each image obtained from the segmentation in the manner shown in Image 4.

The software takes the image of the fingerprint in segmented memory in the form of a pixel vector whose number of elements is equal to the (width×height) of the image.

Then a search of the center part of the print is done using the following process because these areas have the highest curvature of ridges:

Two different measurements are used. The first one measures the cumulative change in the direction of the flow of ridges around all neighboring ones in a pixel block. The second measures the variation of change in direction between one flow of ridges in one pixel block and the flow of ridges in its neighboring blocks.

These two measurements provide the center point of the print and the delta(s) that will be used later on for classification and subclassification (see Image 5). The image is binarized (passed from a gray scale to white and black) where the black pixels represent the ridges and the white ones the valleys.

To create this binarized image, all of the pixels in the image are analyzed to determine whether they should be assigned a white pixel or a black pixel. A pixel is assigned to a binary value based on the direction of the ridge associated with the block in which it is contained. If a flow of ridges is not detected in the block, the pixel is then converted to white. If a flow of ridges is detected, the intensity of the pixel surrounding the actual pixel is then analyzed using a 7×9 grid that is rotated until its rows are parallel to the direction of the flow of the ridge. The intensity of the pixel on a gray scale is accumulated throughout each row rotated on the grid, forming a vector of additional rows. The binary value assigned to the central pixel is determined by multiplying the total center row by the number of rows on the grid and comparing this value to the gray scale intensities accumulated on the overall grid. If the sum of the multiplied center row is less than the total intensity of the grid, then the center pixel is converted to black; otherwise, the pixel is converted to white (see Image 6).

The step following binarization is the calculation of the local orientation of ridges and valleys. To do this, the orientation of ridges and valleys of the image is calculated by dividing the image of the print (Image 7) into non-overlapping blocks of size W×W. The software calculates gradients Gx (i, j) and Gy (i, j) of each pixel (i, j) using the Sobel or Marr-Hildreth operator.

The local orientation of the ridge varies slightly in neighboring blocks where nonsingular points appear (points that are not corer or delta parts of the print). The software applies a low-pass filter to modify the local orientation of the ridge. To apply it, the orientation image is converted into a field of continuous vectors. Then a 2-D low-pass filter size W×W is applied in blocks of 5×5 pixels. From this, the local orientation of each point (i, j) is calculated.

Then the general orientation of the print is calculated depending on the field of orientation obtained in the step above (Image 8).

After that, the grid is configured onto the vector of the image in question, taking preset row and column height and width values (according to the application). Depending on the data obtained by way of the above mentioned algorithms, the center point of the grid is inserted into the center of the image, and its orientation is known by the general orientation obtained from the print in the above step. This step introduces novel aspects compared to current techniques, because while known methods scan minutiae points without relating them with the orientation of the print, which forces you to perform an infinite number of combinations afterwards in order to verify matches of relative distances between them, the proposed method only performs one comparison per minutiae, since all of them come from prints that have been oriented in advance (Image 9).

Then, the software labels the grid with letters and numbers, meaning that it labels the rows with letters and the columns with numbers, or it assigns each square on the grid a number, starting from the center and working outward to the edges clockwise. This allows the number of characters in the resulting chain to be reduced by using just one character per square, and not two like traditional methods use.

After that, the image resulting from inserting the grid onto the fingerprint is displayed on the screen, and this concludes step (C).

Step (D): this step is the one that defines the novelty of the proposed process, and so it is the one that lets you obtain the desired results in terms of accuracy and speed that distinguish this proposed process from other known techniques. It involves a fingerprint classification and subclassification step, depending on the characteristics present on the drawing of the ridges, which prevents you from having to search groups of prints later that have characteristics that are not similar to the ones we want to find. This is the key to obtaining fast and effective results, compared to the traditional methods which, since they do not classify characteristics, require you to search for a print by comparing it with all existing ones.

The software displays on the screen the indications to recognize and identify the four fundamental Vucetich groups, plus exceptions, and the coding system according to the fingers (thumb or other fingers). The exceptions mentioned above come about in cases where the print displays anomalies (scars, injuries, etc.) that prevent it from falling normally into one of the four fundamental groups.

The indications cited above that the software displays on the screen are the location of the center of the print and the location of the delta(s) of the print, if any.

The operator selects the fundamental group to which the fingerprint entered in terms of the above indications belongs, on the basis of which the first character for coding the fundamental group is going to be obtained.

Step (E): The system displays on screen, depending on the fundamental group selected in the above step, the possible subclassifications for this fundamental group. These depend on the type of print you are analyzing, meaning whether it is a rounded, flat or latent print taken using technology stemming from U.S. Pat. No. 6,659,038 or Argentina application P 04 01 01743 that is being processed, using printed ink or live prints using a print sensor.

Subclassification is done according to the following information, keeping in mind that the characters between comas are the subclassification codes the software will take in order to add them to the resulting coding chain.

If the classification selected in the step above is “arch,” for both rolled or flat prints, the possible subclassifications are (see FIG. 9):

“A”: Flat or plain arch: when the papillary ridges run from one side to the other of the print, almost parallel to one another, forming distended arches.
“B”: Left-leaning arch: when one or more independent ridges making up the center of the print have a certain lean toward the left.
“C”: Right-leaning arch: when one or more independent ridges making up the center of the print have a certain lean toward the right.
“D”: Small or low tented arch: when the ridges making up the center of the print go upward toward the upper margin to a relatively low height.
“E”: Large or high tented arch: when the ridges making up the center of the print go up to the top to a relatively significant height.

If the classification selected in the step above is “loop,” both outer and inner, you should keep in mind that there two essential elements to subclassify them: the delta formation (delta) and the core loop (see FIG. 10), considering that for the subclassification exclusively the “core loop” should be taken into account and all the “accidents” that may be present inside it.

“Core loop” should be understood as the core-most papillary ridge, the one that forms a peak curve and doubles back, keeping a certain degree of parallel with the previous one, and goes back toward the same area of the base of the print it started in.

In addition, “delta” should be understood as the more or less regular triangular form that is formed as a result of the confluence of ridges. The delta is made up of three ridges called the ascending line, the descending or directional line, and the appendix or tail.

Consequently, the possible subclassifications when the print being analyzed is plain are (see FIG. 11):

“1”: Clean core loop
“2”: Clean core loop, left branch truncated
“3”: Clean core loop, right branch truncated
“4”: Clean core loop, both branches truncated
“5”: Clean core loop, both branches truncated, with one or more axial lines (either attached or not attached to the top).
“6”: Core loop whose two branches are attached to the same branch of the closest loop (right or left)
“7”: Core loop, left branch truncated, with an axial line (either attached or not attached to the top)
“8”: Core loop, left branch truncated, with two or more lines either attached or not attached to the top)
“9”: Core loop, right branch truncated, with two or more axial lines (either attached or not attached to the top)
“10”: Core loop, right branch truncated, with two or more axial lines (either attached or not attached to the top)
“11”: Double core loop (with or without axial lines)
“12”: Intertwined core loops (with or without axial lines)
“13”: Irregular core loop
“14”: Core loop, with small island or cut not attached to the top
“15”: Core loop, with small island or cut attached to the top
“16”: Core loop with an axial line not attached to the top
“17”: Core loop with an axial line attached to the top
“18”: Core loop with an axial line attached to the top of the left branch
“19”: Core loop with an axial line attached to the top of the right branch
“20”: Core loop with an axial line attached to the bottom of the left branch
“21”: Core loop with an axial line attached to the bottom of the right branch
“22”: Clean core loop forming an enclosure on the left branch
“23”: Core loop forming an enclosure on the left branch, with one or more axial lines (either attached or not attached to the top)
“24”: Clean core loop forming an enclosure on the right branch
“25”: Core loop forming an enclosure on the right branch, with one or more axial lines (either attached or not attached to the top)
“26”: Core loop forming an enclosure on both branches or at the top (with or without axial lines)
“27”: Core loop with an axial line connecting the branches
“28”: Core loop with an axial line that has a clean enclosure (small, medium-size or large), either with or without prolongation, not attached to the top (either with or without up to two other lines)
“29”: Core loop with an axial line that forms a clean enclosure (small, medium or large), with prolongation, attached to the top (either with or without up to two other lines)
“30”: Core loop with an axial line forming a clean enclosure (small or medium), without prolongation, either attached or not attached to the top, with or without up to two other lines
“31”: Core loop with an axial line forming a clean enclosure, large, without prolongation (either attached or not attached to the top, either with or without up to two other lines)
“32”: Core loop with an axial line forming a penetrated enclosure (small, medium or large), with or without prolongation, either attached or not attached to the top, either with or without up to two other lines
“33”: Core loop with an axial line forming a clean or penetrated enclosure (small, medium or large), attached to either of the lower branches (either with or without up to two other lines)
“34”: Core loop with a downward fork or bifurcation not attached to the top (either with or without up to two other axial lines).
“35”: Core loop with a downward fork or bifurcation attached to the top (either with or without up to two other axial lines.
“36”: Core loop with an upward fork or bifurcation either attached or not attached to the top, either with or without up to two other axial lines.
“37”: Core loop with two axial lines not attached to the top.
“38”: Core loop with two axial lines attached to the top.
“39”: Core loop with two axial lines, the left one stunted, the right one either attached or not attached to the top.
“40”: Core loop with two axial lines, the right one stunted, the left one either attached or not attached to the top.
“41”: Core loop with two axial lines, the left one attached to either end of the branch, the right one either attached or not attached to the top.
“42”: Core loop with two axial lines, the right one attached to either end of the branch, the left one either attached or not attached to the top.
“43”: Core loop with two axial lines, the left one a small island or cut (either attached or not attached to the top, the same as the right one).
“44”: Core loop with two axial lines, the right one a small island or cut (either attached or not attached to the top, the same as the left one).
“45”: Core loop with two axial lines, both attached to either end of their branches.
“46”: Core loop with three axial lines reaching the top (either attached or not attached).
“47”: Core loop with three axial lines, the left one stunted and not attached to the branch, the other two either attached or not attached to the top.
“48”: Core loop with three axial lines, the right one stunted and not attached to the branch, the other two either attached or not attached to the top.
“49”: Core loop with three axial lines, the center line stunted, the other two either attached or not attached to the top.
“50”: Core loop with three axial lines, the lateral lines stunted and not attached to the branches, the center line either attached or not attached to the top.
“51”: Core loop with three axial lines, the center line or lateral lines are a small island or cut, and the two either attached or not attached to the top.
“52”: Core loop with three axial lines, the left attached to either end of the branch, the other two either attached or not attached to the top.
“53”: Core loop with three axial lines, the right one attached to either end of the branch, the other two either attached or not attached to the top.
“54”: Core loop with three axial lines, the lateral lines attached to either end of their branches, the center line either attached or not attached to the top.
“55”: Core loop with four or more axial lines or having a diversity of drawings that either reach or do not reach the top, either attached or not attached.
“56”: Double loop or intertwined loop.

“Axial lines” are understood as two ridges (independent lines) that join, touch or come together at the upper edge and are located inside of the core loop.

For rolled prints, they can be subclassified according to the number of ridges between the delta and the core.

Consequently, the type of subclassification would be:

“A”: from 2 to 4 ridges
“B”: from 5 to 8 ridges
“C”: from 9 to 12 ridges
“D”: from 13 to 15 ridges
“E”: from 16 to 18 ridges
“F”: from 19 to 21 ridges
“G”: from 22 to 24 ridges
“H”: from 25 to 27 ridges
“I”: 28 ridges and above

If the classification selected in the previous step is “whorls,” a careful analysis should be done of its core configuration, because depending on the evolution adopted by the ridges in that area, it will be the key to apply.

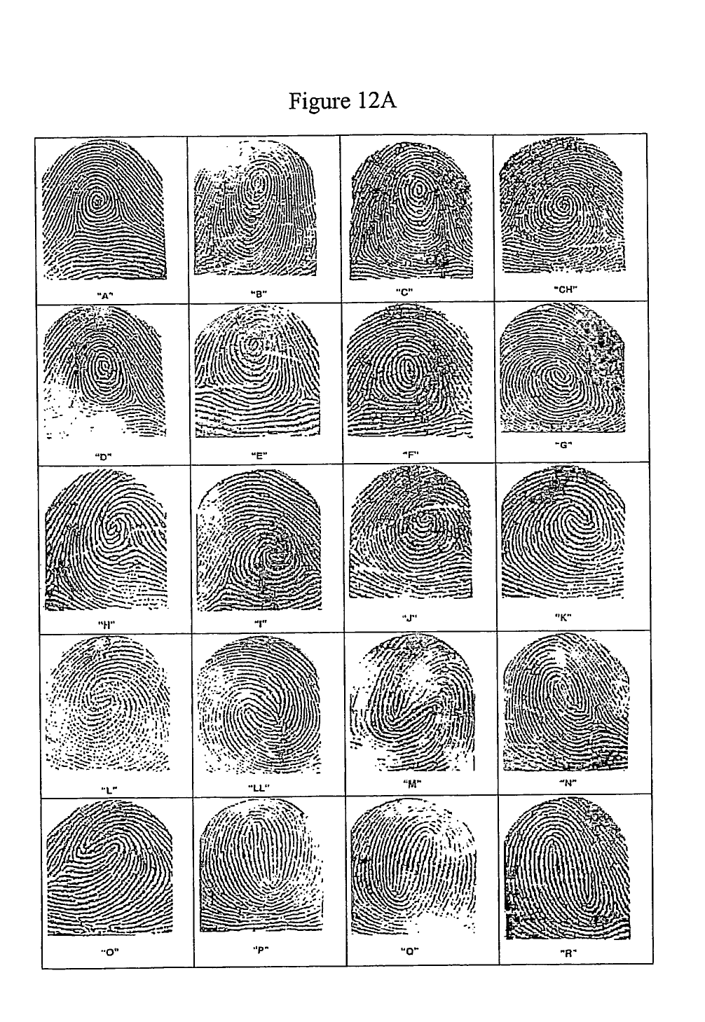

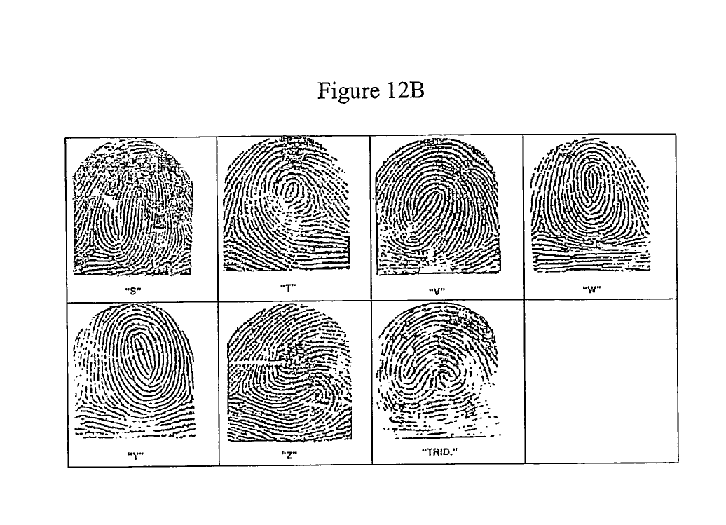

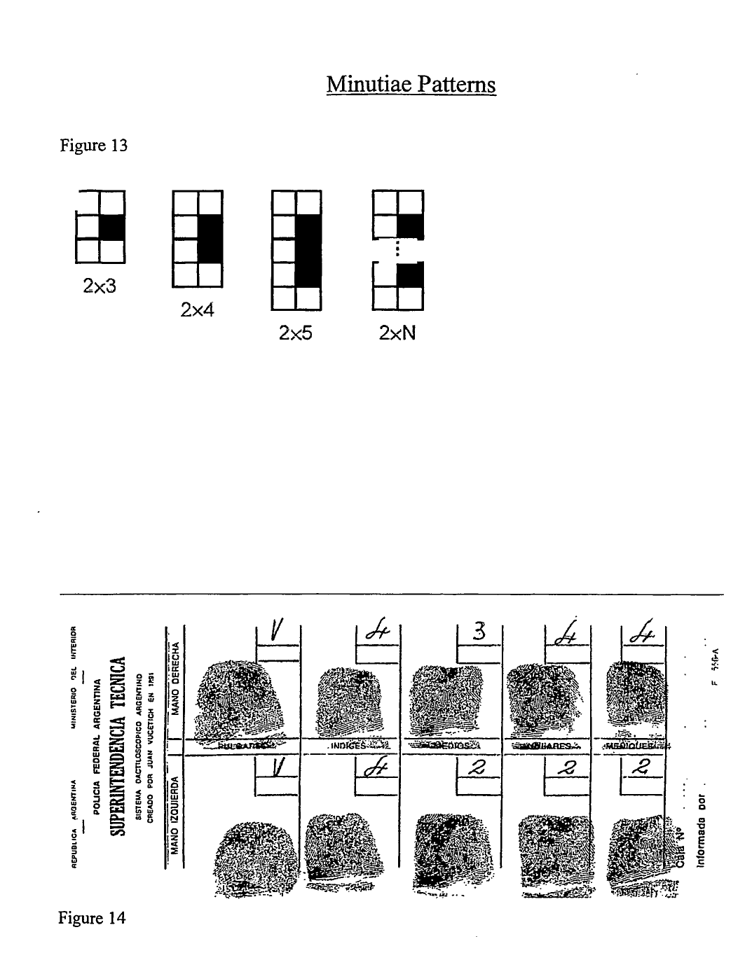

This analysis is just for plain prints, so the possible subclassification are (see FIGS. 12A and 12B):

“A”: Leftward spiral
“B”: Rightward spiral
“C”: Open circumference

### “CH”: Circumference

“D”: Penetrated circumference
“E”: Open circumference
“F”: Elongated spiral
“G”: Simple right core curvature
“H”: Simple left core curvature
“I”: Simple right hooked curvature
“J”: Simple left hooked curvature
“K”: Compound right core curvature
“L”: Compound left core curvature
“LL”: Compound right hooked curvature
“M”: Compound left hooked curvature
“N”: Right angular core curvature
“O”: Left angular core curvature
“P”: Right elongated core curvature
“Q”: Left elongated core curvature
“R”: Right angular elongated curvature
“S”: Left angular elongated curvature
“T”: Normal perfect oval
“V”: Large perfect oval
“W”: Penetrated oval
“Y”: Open oval
“Z”: Independent curvature

### “TRID”: Tridelta

Other Whorl subclassifications for rolled prints are:

By directional lines:

“S”: the descending line of the left delta crosses the descending line of the right delta, with one or more ridges between them.
“D”: the descending line of the left delta passes underneath the descending line of the right delta, with one or more ridges between them.
“M”: both descending lines join at the base of the fingerprint or they do so when the path is long.

To count lines: this is done from the left delta to the core or nucleus of the whorl, by the Galton line.

Galton line is understood as the imaginary straight line running from the delta to the center of the print.

Rules for counting ridges for the nucleus:

“a”: when a spiral is found in the nucleus: the Galton line will be supported on the initial ridge of the spiral, regardless of whether it is a leftward or rightward spiral
“b”: when there are circumferences or clean, open or closed ovals in the nucleus: the Galton line will be supported in the upper cusp of the circle or oval.
“c”: when penetrated open or closed circumferences are present in the nucleus: the Galton line will be supported on the tip or head of the small island or on the same point of penetration.
“d”: when there is simple curvature in the core: the concept for case “a” is applied.
“e”: when there is simple or compound, hooked, same characteristics, short or elongated curvature in the nucleus in a vertical or elongated position: the Galton line will always be supported at the beginning of the curvature, in the cusp or curve of the loop closest to the left delta, or at the top of the center axial line this same loop may have.

Out of the print subclassifications proposed here, you could choose any method or combination, depending on the case to be subclassified.

The operator indicates the subclassification the fingerprint in question pertains to, and then the software obtains the second character for the print subclassification code.

Step (F): The software scans the grids outward from the center toward the edges clockwise.

Step (G): If any minutiae points are detected in the square being analyzed, coding begins by scanning the square from the upper left corner to the lower right corner.

Minutiae detection is done as follows: the software goes over the binarized image of the fingerprint and identifies the pixels that respond to standard minutiae patterns that indicate end of a ridge or a bifurcation. The patterns contain six binarized pixels in a 2×3 configuration (2 columns×3 rows) for ridge ends. This pattern can represent the end of a ridge projecting to the right. It is also valid for a 2×4 pixel pattern. The only difference between this pattern and the first one is that the pair of pixels in the middle are repeated. This group of ridge end patterns can be represented as described above, where the middle pair is repeated “n” number of times (see FIG. 8).

Ridge end candidates are detected on the image by consecutively scanning pixel pairs in the image sequentially, comparing these patterns. Scanning is done both vertically and horizontally.

Using these patterns, a series of candidate minutiae points is detected.

It is also detected whether the minutiae starts or ends (appears or disappears). This determines the direction or placement of the minutiae.

To detect bifurcations, other patterns and a similar process to the one described for ridge ends are used.

The software detects and eliminates false minutiae points, ones that are included on the list of candidate minutiae points obtained in the preceding step. Eliminating false minutiae points includes what are called islands, lakes, dots, minutiae points in low quality regions, hooks, overlaps, pores, etc.

Each minutia is coded considering:
Grid where it is located
Type of minutiae
Quality
Orientation or Direction

Step (H): The values mentioned in the preceding breakdown are four alphanumeric values. As the minutiae points are obtained, their coding is added to the final resulting chain that represents the fingerprint.

Step (I): This involves the final makeup of the resulting chain you want to obtain. The classification code union obtained in step (D) of FIG. (2) (first character)+the subclassification code obtained in step (E) FIG. (2) (second character)+the minutia coding chain obtained in step (H) FIG. (2) generates a series of characters of variable length, unique to every fingerprint, which is called the “alphanumeric chain,” and it constitutes the resulting letter and numerical representation of the processed fingerprint.

It is possible to add any other relevant additional information seen in the fingerprint image. This will give you more information about the fingerprint and will be added to the final alphanumeric chain as complementary information and is of great important when two chains corresponding to fingerprints are compared or to reduce the number of subgroups to be searched. This will give the system a faster response time. All of this depends on the quality of the fingerprint that was captured.

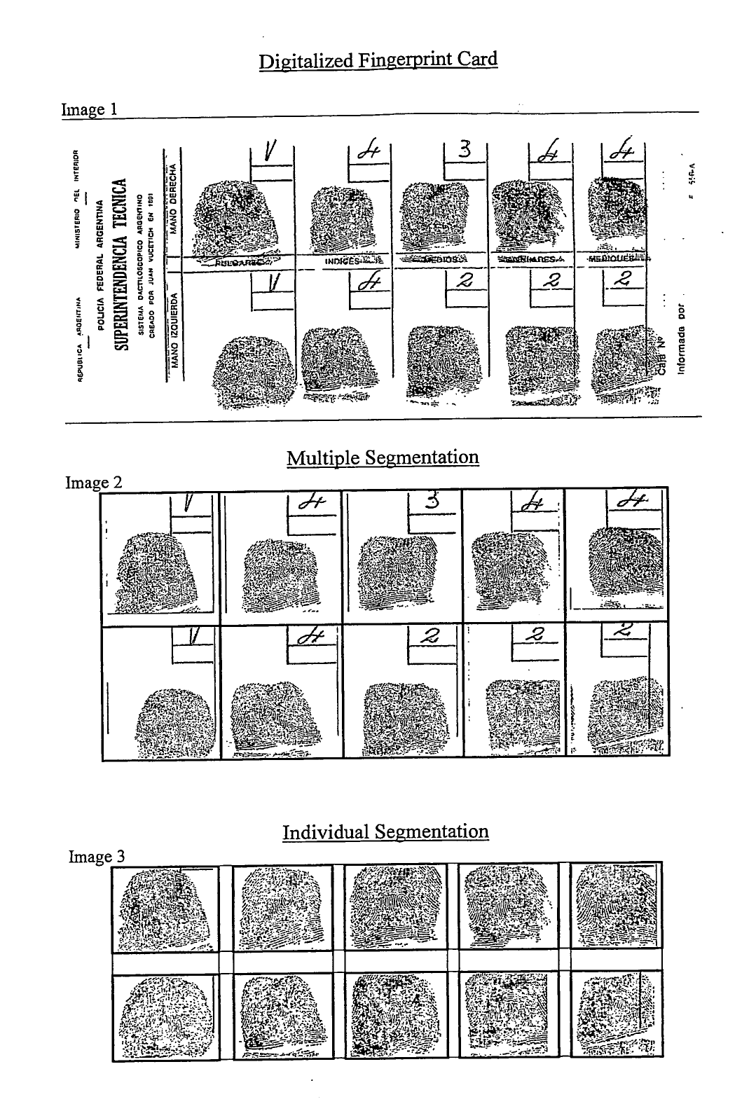

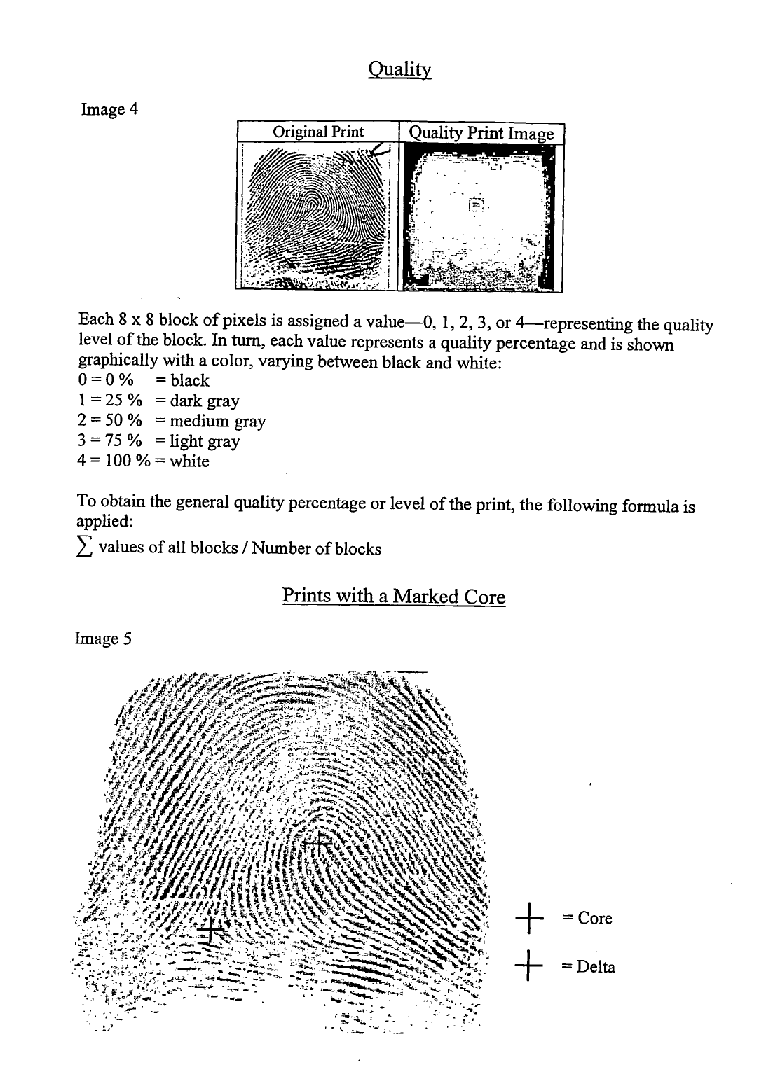

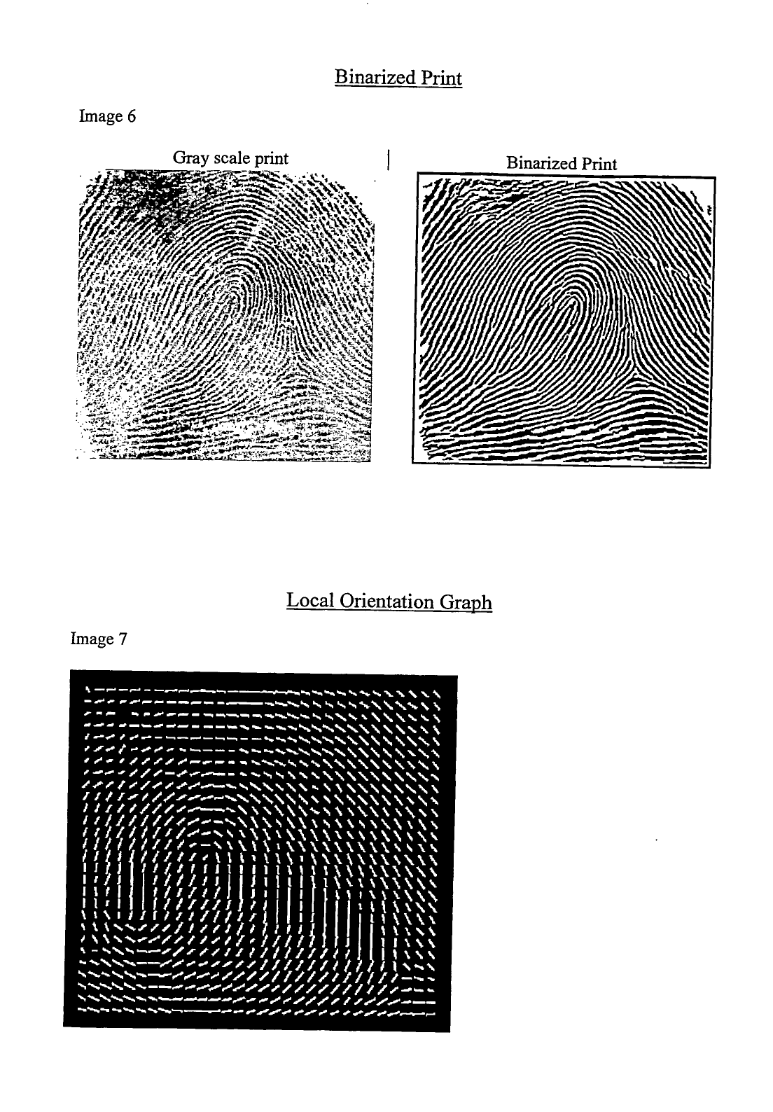

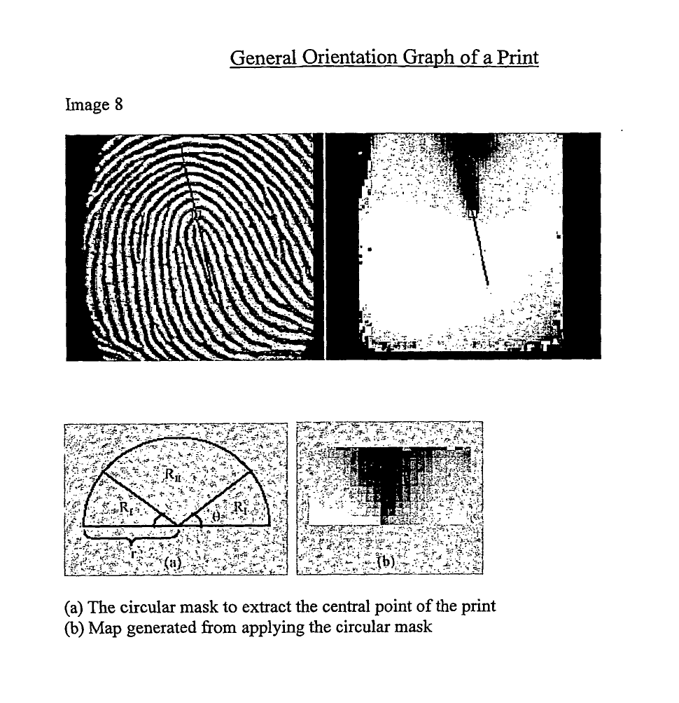

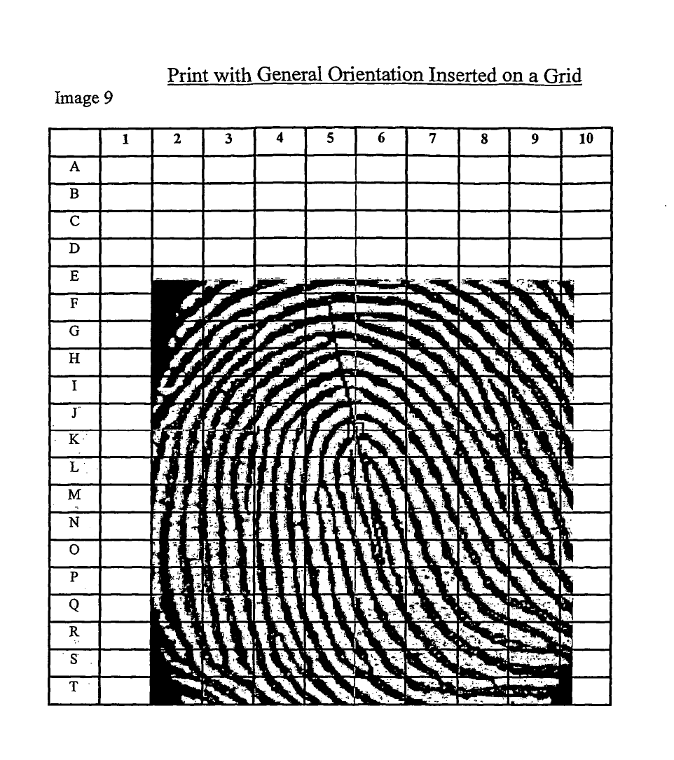

The code can also be the fingerprint identification of a ten-finger print form, a two-finger print form, summarized number, background, document, file, etc. An example of Fingerprint Identification can be seen in FIG. 14.

The last two steps of the process to obtain a character chain from the image of a fingerprint (FIG. 7) are steps (J) and (K), which are presented below.

In step (J) a barcode character coding program is used to represent the character chain(s) obtained. You can represent both a fingerprint as well as any other information that can individualize a person, depending on the case it is applied to, such as:
Identity Credential Number
Name
Fingerprint Identification
Any combination of the above

Depending on the number of characters to be represented, a one-dimensional barcode or a two-dimensional code will be used.

In the next step (K), the software sends the barcode information to be printed by a thermal or laser printer or a printer of similar technology that gives the printed barcode enough quality needed to be read by the laser reader.

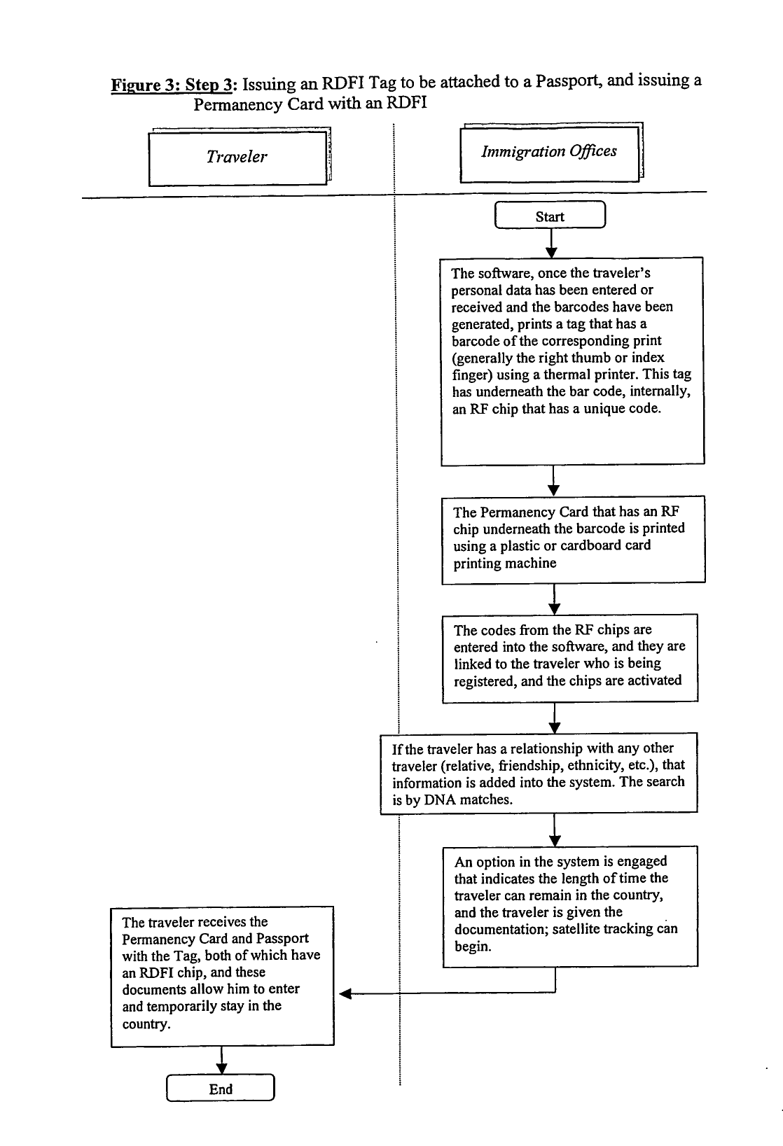

FIG. 3. Step 3: Issuing an RFID Tag to be Attached to a Passport and Issuing a Permanent Card with an RFID

The software, once the personal data of the traveler have been entered or received and the barcodes have been generated (step 2), prints a label or tag with the barcode of the corresponding digit (generally the right thumb or index finger) using a thermal printer. This tag has inside of it, underneath the barcode, an RF chip with a unique code.

Next, the permanency card that has an RF chip underneath the barcode is printed using a plastic card printing machine.

Then the codes from the RF chips are entered into the software, and they are linked to the traveler who is being registered and then activated.

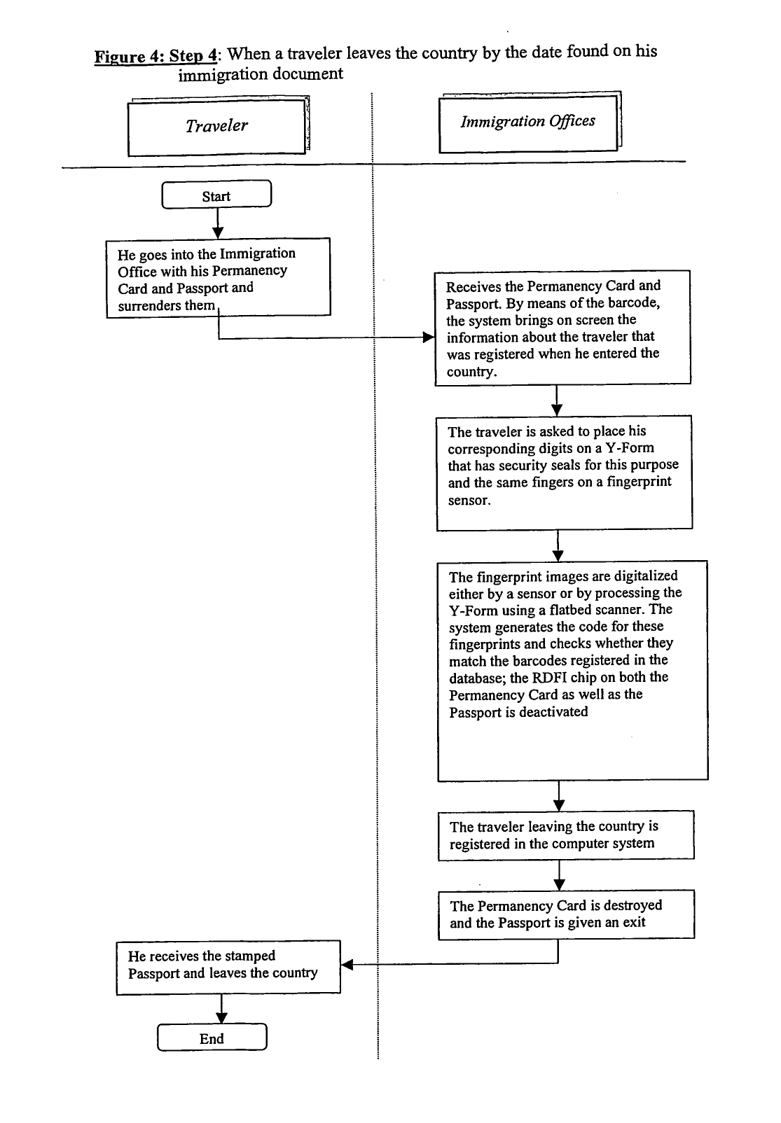

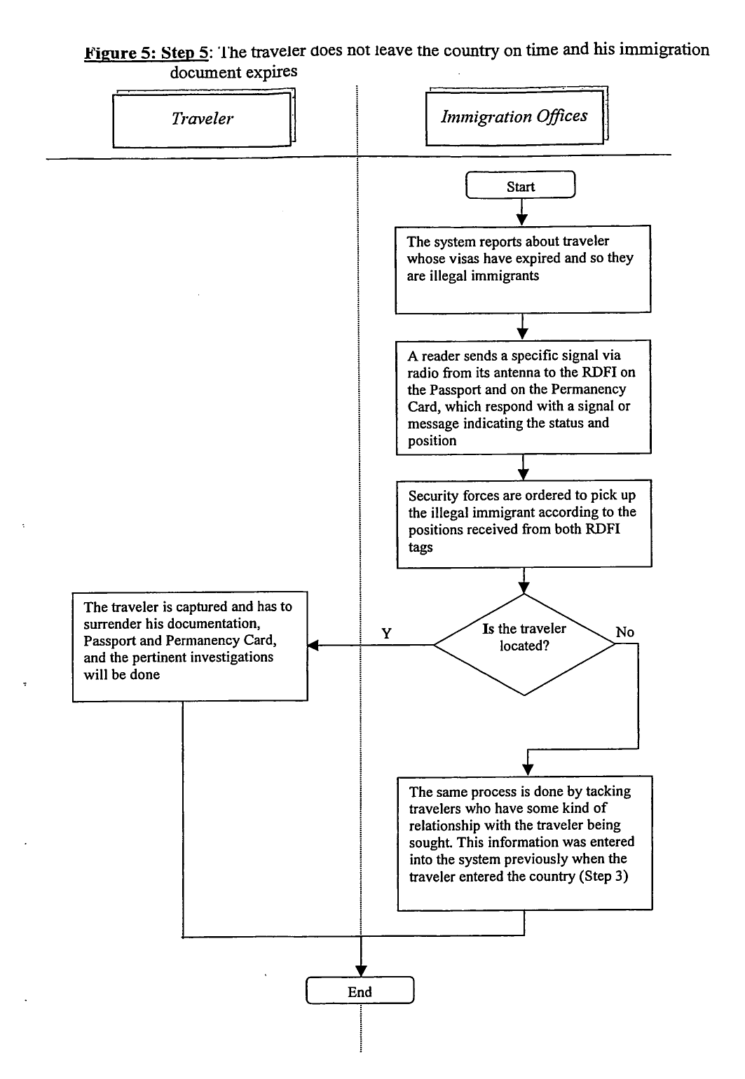

If the traveler has any links with any other traveler (relative, friendship, ethnicity, etc.), that information is added to the software, and an option is activated indicating how long he should remain in the country. The documentation is given to the traveler and satellite tracking is ready to begin. The traveler receives the permanency card and passport that has the tag, both of which have an RFID chip, and he is allowed to enter and remain in the country temporarily. Ps FIG. 4, Step 4: Traveler Leaving the Country Before his Immigration Documents Expire.

The traveler presents his permanency card and passport at the Immigration Department and surrenders them.

The system reads the barcode and brings to the screen the information about the traveler registering when he entered the country.

The traveler is asked to place his fingers on a Y-Form that has a safety seal for this purpose and the same digits on a fingerprint sensor.

The fingerprint images are digitalized either by a sensor or by processing the Y-Form in a flatbed scanner. The software generates the code for these fingerprints and checks to see whether they match the ones on the barcodes registered in the database, after which the RFID chip is deactivated on both the permanency card and passport.

A record is entered into the system that the traveler is leaving the country. The permanency card is destroyed and the passport is stamped with an exit stamp.

The traveler receives his stamped passport and leaves the country.

FIG. 5, Step 5: the Traveler does not Leave the Country on Time and his Immigration Document expires.

The software, according to the location screen or map, reports about travelers whose immigration documents have expired and who are, therefore, illegal immigrants.

A reader sends a specific signal via radio from its antenna to the RFID tag on the passport and immigration document, and these documents respond with a signal or message indicating where they are and their position.

Security forces are ordered to pick up the illegal immigrant according to the position received from both REID tags. If the traveler is captured, he has to surrender his documentation, passport and immigration card, and the pertinent legal actions are taken.

If the traveler is not located, the same tracking process is done for travelers who are somehow related to the traveler who is being sought. This information was already input when the traveler entered the country (Step 2).

A country's Immigration Department can in this manner monitor up to 200 visa tags per second, which will enable them to calculate the number of travelers who are not complying with the immigration law.

The use of immigration tags and credentials through radio frequency identification (RFID) is a procedure that is connected to the barcode that generates the fingerprint and makes it possible to identify a person and an object, in this case the passport (or a vehicle, driver's license, etc).

In this manner, everyone has an RFID with a chip attached to his passport and temporary immigration card, and this chip issues signals with a code similar to the fingerprint barcode containing the EPC (Electronic Product Code), which allows you to capture a person's unique fingerprints. In this case, the information is added to a database, and you are ready to identify and track the movements of that person.

As stated above, this technology consists of an antenna and a transmitter/receiver that reads the information incrusted on the tag affixed to the passport and immigration credential the traveler receives, on the clothing of soldiers, etc., and it transmits the information via wireless radio waves to a device that processes it. It is an integrated circuit.

This technology, which is classified as an Automatic Identification System, can be used in several applications where a traveler, passport, soldier, automobile, animal, etc. needs to be identified and tracked.

This technology, together with the fingerprint coding system done by the software, allows you to represent the print in a barcode and print it on a pre-prepared self-adhesive tag with a passive RFID system, and this way it lets you monitor over distances using a satellite GPS system and on the ground using the laser reader system to reveal the information contained on the tag.

It is important to mention the difference between the proposed procedure as it is being used today compared to RFID technology: while nowadays we track people as a way of protecting ourselves, for example, from kidnappers, by having the user implant the radio frequency chip underneath the person's skin, the proposed procedure achieves the desired objective in a non-invasive manner, because the signals the reader receives come from a chip that is inserted into a passport or temporary immigration document the person is always carrying with him, and this makes invasive methods like the ones currently being used unnecessary.

The proposed permanency card or passport is created in just three laminating steps, and the radio frequency chip is enclosed between two layers of cardboard—a base layer and a termination layer—and the chip is undetectable by mere sight or touch. In addition, it is put in the middle of the card, where the barcode generated by the person's fingerprints will be printed later on. The key components of the proposed RFID system are two: the tag and the reader. The tag contains a microprocessor and a small antenna. The coded fingerprint impression generated by the software and printed on the visa tag to enter the country is added to this and affixed to passports, in addition to this information being printed on a permanency credential or card also contained in the microprocessor.

RFID tags or labels will be able to be used in such important fields as the identification of objects and people.

To unequivocally identify a person, an Electronic Persons Code (EPC) is used. It is a 96-bit code that identifies an object or person uniquely by using a field series: country code, person code, and DNI or identity document number. The EPC can be used as a reference, enabling the location of information relative to the object and person through a computer connected to the system network.

This reference is expressed in a number that leads to the associated file stored in the database. This file contains complete, accurate, structured and real-time information.

This way, an important supporting device is required to process, analyze, and cross-compare the data obtained and draw automatic conclusions that can be expressed in confidential and State information.

Another element in the tag is ONS (Object Naming Service), which permits a connection between the EPC and its data file written in PML (Physical Markup Language). It includes a group of outlines that describes the required aspects of the physical objects. This language is designed to store data about physical objects.

ONS is a automated network service so that when a determined EPC is introduced, it directs this EPC to the PML file via a specialized server.

Currently there are procedures that let you optimize the flow of information between servers. It should be mentioned that you do not need to obtain the information with excessive frequency, and most queries are simple. The local server associates and engages the database and communicates the location of the person and object, in this case the passport with its information, to the ONS servers. These servers, in turn, send the information to the PML files to be consulted.

Tag memory can be volatile or static, depending on the kind of application the RFID device is designed for. Volatile memory lets information on the RFID tag be changed and updated, while static tags basically store information that can only be read as a serial number or other identification code.

Readers, for their part, are devices that communicate with the tags and credentials and send information to the server.

By implementing tags and credentials for immigration and security via RFID, significant benefits are obtained in the field of interior security since these objects have been given a certain degree of “intelligence” during the manufacturing process.

The potential impact on safety and crime prevention that these processes have by interacting is very important. Implementing the proposed process has a vast number of advantages compared to known systems, since it makes identity falsification difficult because the system is based on a barcode generated by the person's fingerprint. By providing the means for the card or tag to communicate efficiently with its surroundings, the system allows information to be obtained and kept in it and has a language that can express its features, production demands, etc.

It is evident that to implement a procedure such as the proposed one, it is essential to design an architecture and infrastructure that includes the installation of recognition and administration software, inventory management, and a supporting service and remote information storage. These dedicated systems can be stored in a Data Center that is connected to the networks of the company requiring the system by using high speed links. All of this backoffice, which can be totally externalized or outsourced, generates online reports.

A good option, for example, is implementing servers working under ERP software to automatically process transactions. Some background is known about this technology that was developed by the Sun Microsystems firm, and this technology has a special solution in this field called Sun Java System RFID which is available on the Solaris operating system. It also provides the base for RFID applications that will increase the visibility of merchandise via the supply chain, assisting in the integrity of productivity. It offers real-time access to inventory information. The system is designed to work with several infrastructure solutions, including the Sun Java Enterprise System.

This way, every passport or temporary immigration credential has a tag attached to it that has an RFID chip and a printed barcode that emits a code, the EPC (Electronic Persons Code), which lets you pick up the unique digits of the person over a long distance.

In this case, the information could be incorporated into a database, enabling information processes to take place, especially in what is referred to as tracking the life of an object over a certain period of time, thanks to an incorporated RFID chip.

This system can be configured to read and control one or two parameters according to needs and administered centrally by a server. Even in organizations that have several branches, everything can be managed centrally, with information being received from all points and then put into an internal network or by way of webservers.

Both kinds of information can even be mixed together so that the system controls the movement of a temporary visitor in the country who has an RFID card or credential. On the other hand, the system can identify the bearer of the passport that has an RFID identification tag.

This way the data from both records are processed automatically in order to enable the movement of these records.

In general terms, the purpose of this invention lies is that it offers Nation's the possibility of obtaining crime prevention and security for the Nation's defense and prevents attacks on its sensitive points.

For example, a Control Department could activate and deactivate transmitters whenever it wants and how ever it wants for better tracking so it can determine, among other things:

Entry into the Country: from the immigration card or form every foreigner entering the country has to fill out, regardless of the means of transportation used;

At the booth at the State Immigration Office, a tag that has a barcode like the one printed on the entry form the traveler completed with his data is put into place. This self-adhesive tag is affixed to the passport like a seal and the visa is activated;

When the tag is printed by the State, it is activated and attached to the passport as if it were a visa, and the State can then track the location of that passport by satellite whenever it wants and can deactivate it when the bearer of that passport leaves the country. If the situation has to do with a matter of State, the passport can be tracked anywhere in the world;

The State can control all kinds of visas it issues, such as, tourist visas, student visas, business visas, visas to attend a conference, commercial visas, etc. in order to have control over and track every person and know whether the traveler is violating the temporary visa that he was issued or has exceeded the amount of time he permitted to stay in the country, and in this way he can be located by the place where his passport is found. This would substantially reduce illegal immigration.

The system keeps track of and registers travelers from the moment they enter the country until they leave. The pertinent database will let the State obtain up-to-date information about travelers who are in its territory.

To put this invention into practice, there has to be enough technology to install a wide range of antennas and satellite technology to report and give the correct location of the transmitter installed in the form of a tag on any object involved. In this case the object is the traveler's passport.

To do this, the receivers or antennas have to be perfectly adjusted to the width of the signal the chip emits, and these tags can be configured according to the characteristics you want to obtain about the passport or credential without being noticed. The chip is installed when the tag or credential is manufactured or by printing a self-adhesive or stationary tag. These can be inviolable. The radio frequency signal will be captured by strategically located receiving antennas and by satellites according to the characteristics of the load of the chip or MEMS to be exposed.

This exposure of the chip to the radiation load takes into account the intensity and type of emission. The characteristic of the medium and of the chip or MEMS will be given the right size, form, electrical properties, wave length, and position in the radiation field.

This system is necessary for security because it can interact with high-speed and complicated processes via a data communication channel of limited band width, maintaining a highly reliable and efficient distance control. It enables the implementation of intelligent networks distributed by using flash microprocessors working in parallel.

The modular and specific block architecture will be installed according to a customer's needs, enabling him to configure the most adequate solution to solve any practical application without needing to waste resources. The facilities provided by the configuration software lets you set the parameters for just the right application.

The system constitutes an application especially designed for locating immigration cards and passports, telemeasuring remote parameters, and control over variables using a radio link.

The immigration control center will be responsible for collecting and processing the information generated by the GPS in order to obtain the minimum data needed to facilitate the system's operation: position of the person, displacement speed and place. This information will be compressed in the terminal to optimize transmission time to the central system.

These data will not be automatically updated by the system so as to prevent air channel congestion, and information can be collected by special order from the central system.

It is evident that several operating modifications can be introduced in the procedure we are describing, as well as to the design and configuration of the device, without moving away from the scope of this invention patent, which is clearly determined by the scope of the following claims.

1) A person identification and location procedure by radio frequency tags (RFID) that have an incorporated chip including the following steps:
obtaining a fingerprint by a digital device;
plotting the digital image of a print onto a predetermined alphanumeric two-dimensional grid or stencil in segments and measurements identified by letters and/or numbers;
classifying the print into one of the possible existing groups;
subclassifying the print according to the classification to which it belongs;
determining the characteristic points of the fingerprint are determined and coded in alphanumeric information;
converting the alphanumeric code obtained into barcodes using conventional methods;
providing an RFID tag that contains a chip and an antenna hidden between the tag's layers of lamination;
printing the barcode resulting from the fingerprint entered onto the RFID tag;
providing a permanent card that has a hidden RFID chip and antenna;
entering the barcode resulting from the fingerprint onto the permanent card and printing with a hidden RFID chip;
registering the unique code of each chip in a software system, and activating the chips and entering additional information; and
satellite scanning of the tag that has the hidden RFID tag.

2) The person identification and location procedure, according to claim 1, wherein prior to the classification and subclassification steps, steps involving segmenting the image obtained, dividing the image containing several fingerprints into several separate images each containing a fingerprint are added, and each of them is worked individually according to the following steps:
segmenting each image eliminating the pixels that do not pertain to the print;
improving the image by eliminating noise;
analyzing the quality of the print, and obtaining a quality index, if it is the right one, the image is processed as follows:
searching on the core of the print;
binarizing the image where black pixels represent ridges and white ones the valleys;
calculating the local placement of ridges and valleys;
calculating the general orientation of the print;
configuring the grid and inserting its central point in the center of the image;
numbering the grid and lettering the grid and each square is assigned a character;
inserting the grid onto the fingerprint to obtain an image which is displayed graphically.

3) The person identification and location procedure, according to claim 1, including the following steps:
inputting a person's personal data taken from his documentation;
obtaining the person's fingerprint by way of an organic safety seal that lifts off remains of cells attached to an adhesive material on that organic seal;
capturing the fingerprint by a digital medium and digitalizing the image obtained or the image of the prints obtained by the safety seal;
processing the digitalized prints and generating the corresponding barcode; and
transmitting the barcode that was obtained plus the person's personal data to the country he is traveling to.

4) The person identification and location procedure according to claim 1, including the following steps:
presenting a passport to the authorities of the country in which the traveler arrives;
taking the traveler's personal data from his documentation and entering it into the system;
obtaining the person's fingerprint using an organic safety seal that lifts off cell remains attached to the adhesive material of the organic seal;
capturing the fingerprint by a digital medium, and digitalizing the image that was obtained or the prints obtained using the safety seal;
processing the digitalized prints and generating the corresponding barcode.

5) The person identification and location procedure according to claim 1, wherein the barcode obtained is linked to the rest of the person's information.

6) The person identification and location procedure according to claim 1, wherein the step for determining the characteristic points of the fingerprint and coding them into alphanumeric information is done taking into consideration the specific square of the grid the characteristic point is found.

7) The person identification and location procedure according to claim 1, wherein the search the software performs is based only on certain characteristic points of the alphanumeric chain.

8) The person identification and location procedure according to claim 1, wherein the search the software does is by scanning only certain squares searching out matching points.

9) The person identification and location procedure according to claim 1, wherein the search the software performs is done by combining certain characteristic points of the alphanumeric chain in specific squares.

10) The person identification and location procedure according to claim 1, including the steps of:
presenting a passport to the authorities of the country the traveler is leaving;
reading the barcodes on the documentation and transmitting the traveler's personal data that was registered when he entered the country to the system;
obtaining the person's fingerprint by way of an organic safety seal that lifts off cell remains attached to the adhesive material of this organic seal;
capturing the fingerprint using a digital medium, and digitalizing the image that was obtained or the print image obtained using the safety seal;
processing the digitalized prints and generating the corresponding barcode, if it matches the one registered in the database, it is the same person;
deactivating the RFID chips;
wherein the traveler leaving the country is registered in the system, his passport is stamped, and the permanent card is destroyed.

11) The person identification and location procedure, according to claim 1, including the following steps:
reporting via the software, according to the location screen or map, on travelers whose visas have expired;
sending a specific signal via radio from its antenna to the RFID tag on the passport and on the permanent card, which responds with a signal or message indicating their status and position;
determining the traveler's location and depending on the positions received from both RFID tags, taking the pertinent legal action;
wherein if the traveler is not located, the same tracking process is used to track people who are related to the traveler being sought, according to the information that was previously entered into the system when the traveler entered the country,

12) The RFID tag that includes a chip and an antenna that issues and receives signals on a certain frequency as claimed in claim 1, is passive.

13) The RFID tag that includes a chip and an antenna that issues and receives signals at a certain frequency as claimed in claim 1, is active and includes an internal battery.

14) The RFID tag that includes a chip and an antenna that issues and receives signals at a certain frequency as claimed in claim 1, contains conductive inks that replace copper antennas.

15) The RFID tag that includes a chip and an antenna that issues and receives signals at a certain frequency as claimed in claim 1, has just one reader.

16) The RFID tag that includes a chip and an antenna that issues and receives signals at a certain frequency as claimed in claim 1, has a reader and writer.

17) The RFID tag that includes a chip and an antenna that issues and receives signals at a certain frequency as claimed in claim 1, uses a printed EPC (Electronic Product Code).

18) The RFID tag that includes a chip and an antenna that issues and receives signals at a certain frequency as claimed in claim 1, includes an ONS system (Object Naming Service).

19) The RFID tag that includes a chip and an antenna that issues and receives signals at a certain frequency as claimed in claim 1, includes sensors.

20) The RFID tag that includes a chip and an antenna that issues and receives signals at a certain frequency as claimed in claim 1, includes MEMS (Micro Electro-Mechanic Systems).

21) The device as claimed in claim 1, which includes a series of interrelated devices or apparatuses such as a digital image capturing medium, a computer containing software, a database, a laser barcode reader, a printer, an RFID transmitter, a reader that issues signals on a predetermined frequency to the RFID transmitters contained in its range of reach, a computer network, recognition and administration software, a supporting service, and remote information storage.
